(19) United States
(12) Patent Application Publication
(10) Pub. No.: US 2018/0096369 A1
(43) Pub. Date: Apr. 5, 2018

(54) SYSTEMS AND METHODS FOR AUTOMATING THE PRESENTATION OF DATA AND CONTENT

(71) Applicants: Bradley KAYTON, Hollis, NH (US); Alexei FEDOSSEEV, San Jose, CA (US)

(72) Inventors: Bradley KAYTON, Hollis, NH (US); Alexei FEDOSSEEV, San Jose, CA (US)

(21) Appl. No.: 15/720,732

(22) Filed: Sep. 29, 2017

Related U.S. Application Data
(60) Provisional application No. 62/402,421, filed on Sep. 30, 2016.

(51) Int. Cl. G06Q 30/02

(52) U.S. Cl. CPC G06Q 30/0203; G06F 3/0483

(57) ABSTRACT

Method for automating presentation of data and content is disclosed. According to the method, electronic information to be provided about a poll may be configured, so as to create a configuration. The electronic information may comprise statistics about the poll. The configuration may be conditional based on a parameter or static. The configuration may indicate what electronic information is to be provided in response to a user request for additional information regarding the poll. The configuration may be stored in a content repository. In response to the user request, the electronic information to be provided based on the configuration may be retrieved. The electronic information to be provided based on the configuration may be analyzed. The configuration may further indicate what electronic information is to be analyzed. The electronic information may be provided to the user.

### CROSS-REFERENCE TO RELATED APPLICATIONS

This application claims priority to U.S. Provisional Application No. 62/402,421, filed Sep. 30, 2016, which is incorporated by reference as though fully included herein.

### FIELD OF THE DISCLOSURE

This application generally relates to software systems and methods to automate the presentation of data and content within a web page, mobile phone application, or similar digital screens of information, in a way that there may be higher engagement for online end-users—or the measurement of this engagement—based on relevant and supporting information to an initial and main content theme. The power of interactivity may be choice of navigation, choice of what to read or consume, and simultaneously the opportunity for web publishers of data to enhance the information gathering and understanding process, which in turn allows for increasing engagement with the content.

### BACKGROUND

Web publishers have a keen interest in raising engagement rates of their content. The shift in the publishing industry to online publishing medium has brought a revolution in the way news is produced and consumed. Along with this transformation of the publishing industry comes challenges. The low entry barrier, outdated tools, declining ad revenue and the decimation of the once profitable classified sections of newspapers, and continuous change in search engine algorithms, combined with short-attention span of the online audiences has caused major problems. It has forced many online publishers to search for ways to increase online engagement rates, either by content subscriptions from avid fans (committed readers) of the content provider or online advertising to readers on the web site or mobile app. The disclosure detailed herein is meant to address the problems facing web publishers by helping them increase their engagement rates with each individual end-user web visitor.

### SUMMARY OF THE DISCLOSURE

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

In one embodiment, the techniques may be realized as a computer-implemented method for automating presentation of data and content. The method may be performed by a computing device. The computing device may comprise one or more processors. According to the method, electronic information to be provided about a poll—a question on some topic of interest with two or more options as answers selected by the online end-user—may be configured, by the one or more processors, so as to create a configuration. The electronic information may comprise statistics about the poll. The configuration may be conditional based on a parameter or static. The configuration may indicate what electronic information is to be provided in response to a user request for additional information regarding the poll. The configuration may be stored, by the one or more processors, in a content repository. In response to the user request, the electronic information to be provided based on the configuration may be retrieved by the one or more processors. The electronic information to be provided based on the configuration may be analyzed by the one or more processors. The configuration may further indicate what electronic information is to be analyzed. The electronic information may be provided, by the one or more processors, to the user.

In accordance with other aspects of this embodiment, the method may further include providing, by the one or more processors, the electronic information on a second page that shares a look-and-feel of a first page where the poll question and text of one or more answers of the poll is displayed.

In accordance with other aspects of this embodiment, the method may further include providing, by the one or more processors, electronic information to encourage participation of the poll if the participation of the poll is below a threshold.

In accordance with other aspects of this embodiment, the method may further include comparing, by the one or more processors, differences in answers of the poll between a first publisher of the poll and a second publisher of the poll.

In accordance with other aspects of this embodiment, the method may further include configuring, by an administrator of a publisher of the poll, the electronic information to be provided about the poll.

In accordance with other aspects of this embodiment, the method may further include providing, by the one or more processors, the electronic information on a second page within a first page where the poll question and text of one or more answers of the poll is displayed.

In accordance with other aspects of this embodiment, the method may further include providing, by the one or more processors, a source article associated with the poll.

In another embodiment, the techniques may be realized as a computer-implemented method for automating presentation of data and content. The method may be performed by a computing device. The computing device may comprise one or more processors. According to the method, electronic information about users may be gathered by the one or more processors. At least some of the electronic information may reflect a first trait of a first user and a second trait of a second user. The users may be profiled, by the one or more processors, based on the electronic information. Electronic content may be presented, by the one or more processors, to the users according to users' profiles. The first user with the first trait may be presented with the electronic content in a first form and the second user with the second trait may be presented with the same electronic content in a second form.

In accordance with other aspects of this embodiment, the first trait may comprise at least one of a world view or a belief of the first user.

In accordance with other aspects of this embodiment, the method may further comprise profiling, by the one or more processors, the first user based on a two-by-two matrix comprising four quadrants.

In accordance with other aspects of this embodiment, the method may further comprise profiling, by the one or more processors, the first user based on Social Dominance Orientation and Right-Wing Authoritarianism.

In accordance with other aspects of this embodiment, the method may further comprise presenting, by the one or more processors, the first user with the content in a first narrative form and presenting, by the one or more processors, the second user with the same content in a second narrative form.

In accordance with other aspects of this embodiment, the first narrative form may conform to the first trait of the first user and the second narrative form may conform to the second trait of the second user such that the first narrative form enhances a first agreement of the first user with the electronic content and the second narrative form enhances a second agreement of the second user with the same electronic content.

In accordance with another embodiment, the techniques may be realized as an article of manufacture including at least one processor readable storage medium and instructions stored on the at least one medium. The instructions may be configured to be readable from the at least one medium by at least one processor and thereby cause the at least one processor to operate so as to carry out any and all of the steps in the above-described method.

In accordance with another embodiment, the techniques may be realized as a system comprising one or more processors communicatively coupled to a network; wherein the one or more processors are configured to carry out any and all of the steps described with respect to any of the above embodiments.

### BRIEF DESCRIPTION OF THE DRAWINGS

Better understanding of the present disclosure may be obtained by reference to the accompanying drawings, when considered in conjunction with the subsequent, detailed description.

FIG. 1 is an example of an Insights Page for a poll question, in accordance with an embodiment of the present application.

FIG. 1.1 is another example of an Insights Page, in accordance with an embodiment of the present application.

FIG. 2 is an example of a “third page” Insights Page launched from within an Insights Page, in accordance with an embodiment of the present application.

FIG. 3 is a flow chart illustrating an exemplary method 300 for providing Insights Page, in accordance with an embodiment of the present application.

FIG. 4 shows a block diagram with components for providing Insights Page, in accordance with an embodiment of the present application.

FIG. 5 is an example of a 2×2 matrix using SDO as one axis and RWA as the other axis, in accordance with an embodiment of the present application.

FIG. 6 is an example of a 2×2 matrix using SDO as one axis and RWA as the other axis, showing exemplary low and high in Social Dominance Orientation, in accordance with an embodiment of the present application.

FIG. 7 is an example of a 2×2 matrix using SDO as one axis and RWA as the other axis, showing exemplary low and high in Right-Wing Authoritarianism, in accordance with an embodiment of the present application.

FIG. 8 is an example of a 2×2 matrix using SDO as one axis and RWA as the other axis, showing an exemplary person mapping onto the 2×2 matrix, in accordance with an embodiment of the present application.

FIG. 9 is another example of a 2×2 matrix using SDO as one axis and RWA as the other axis, showing an exemplary person mapping onto the 2×2 matrix, in accordance with an embodiment of the present application.

FIG. 10 is an example of scoring for five exemplary questions indicating worldview, in accordance with an embodiment of the present application.

FIG. 11 shows example scores of an end-user answering five questions.

FIG. 12 is exemplary SDO and RWA scores of a user, plotted in a 2×2 matrix using SDO as one axis and RWA as the other axis, in connection with FIG. 11, in accordance with an embodiment of the present application.

FIG. 13 is a flow chart illustrating an exemplary method 1300 for Smart Profiling and Presentation, in accordance with an embodiment of the present application.

FIG. 14 shows a block diagram with components for providing Insights Page, in accordance with an embodiment of the present application.

FIG. 15 is an example of an In-Place Analytics Widget, which may be inserted into a space in a Third-party Web Site, in accordance with an embodiment of the present application.

FIG. 16 is an example of In-Place Analytics Widget, in accordance with an embodiment of the present application.

FIG. 17 is another example of In-Place Analytics Widget, in accordance with an embodiment of the present application.

### DETAILED DESCRIPTION

This application generally relates to software systems and methods to automate the presentation of data and content within a web page, mobile phone application, or similar digital screens of information, such that higher user engagement may be achieved. The higher user engagement may be achieved via choice of navigation, choice of what to read or consume, and simultaneously the opportunity for web publishers of data to enhance the information gathering and understanding process. In a first embodiment, through an Insights Page, additional information about a poll may be provided. In a second embodiment, through Smart Profiling, users may be presented with content that have been customized for their traits, such as their world views. In a third embodiment, through In-Place Analytics, the additional information about a poll may be provided as a module that can be plugged into a web page of a third party content provider.

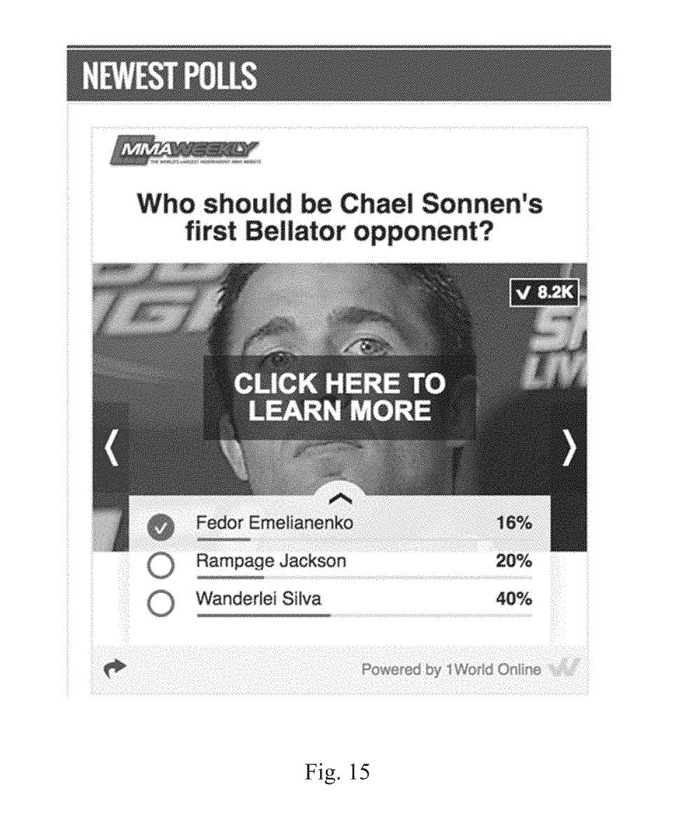

“Engagement” generally describes the interest in interacting with the content and interactive elements presented to end-users, such as voting on a poll or clicking on “Learn More” (see, e.g., FIG. 15). It may also be associated with better comprehension and processing of the material, better enjoyment of the subject matter, and increased statistics of web viewing such as more time on the site (section of the site, technically) and/or more monetization achieved by more (and more relevant) advertisements able to be displayed.

The disclosure detailed herein thus may help achieve higher engagement with the content being presented to the end-user. These additional pages—and/or additional information in-situ within the spot on the web page—of Insights (e.g., statics about the poll, source article of the poll) on poll or other “interactive elements of choice” results, or putting web pages of data through a filter depending on their psychographic outlooks and worldviews can be applied simultaneously. The expected result of using these disclosure herein simultaneously may be even higher engagement.

### First Embodiment: The Insight Page

An Insight Page is a web page, or content provided in another form, that provides additional information about a poll. In a first embodiment, new sophisticated web or mobile pages may be created dynamically, along with new ad inventory, for publisher customers. When a poll vote is executed within a 1World widget, certain areas of the interactive widget may allow the user to launch a “Second Page” by clicking on a trigger, such as the word “Learn More.” The trigger may be overlying the poll results or similar interactive content, which in turn is usually related to the article on the publisher's web site. This Second Page may present the user with automatically generated analytics and engagement elements including graphs showing voting results, interactive maps of voting results, relevant partner widgets (e.g., comments, e-commerce recommendations, additional interactive content), video clips, and other graphical and informative modules that provide cohesive experience between the two pages. It should be noted that the present invention is not limited to the specific embodiment of 1World widget.

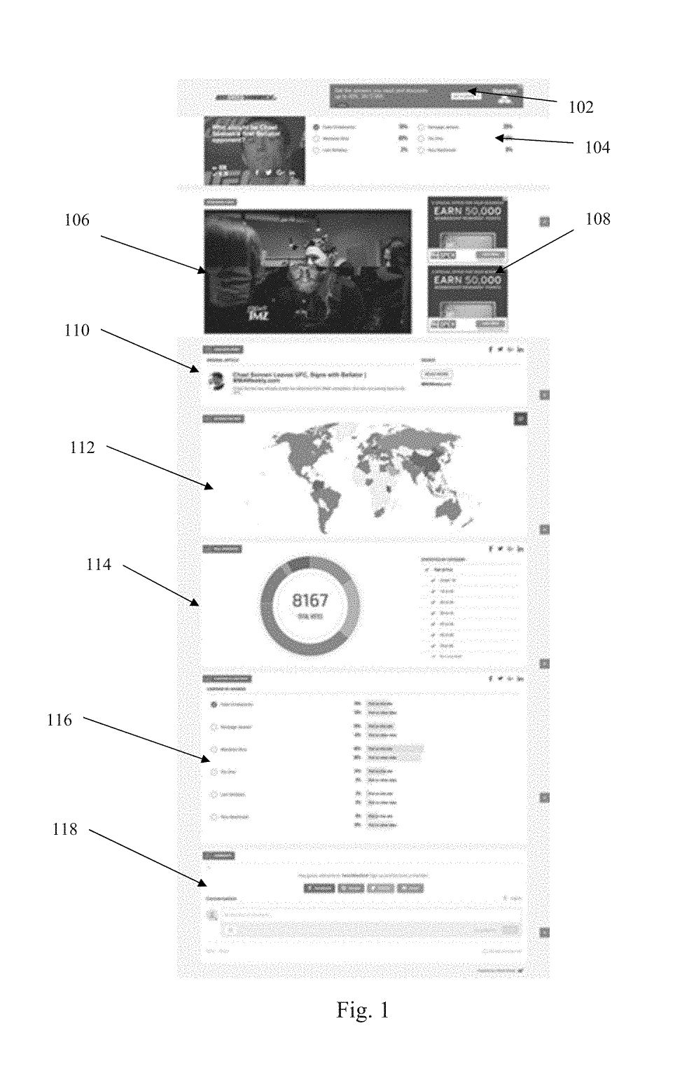

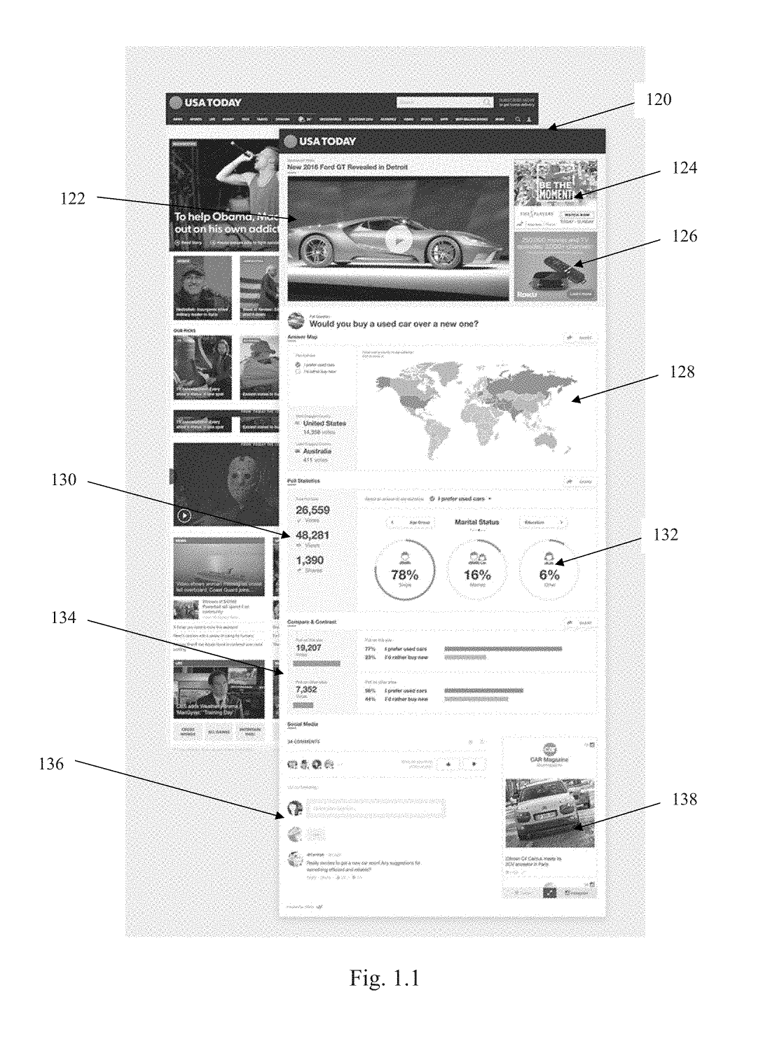

FIG. 1 is an example of an Insights Page for a poll question, in accordance with an embodiment of the present application. When someone clicks a trigger area of the screen, like the hyperlinked text “Learn More” (see, e.g., FIG. 15), a second, related Insights Page may be displayed, as a pop-up new web browser window or in a new web browser tab.

At the very top, there may be the logo of the web publisher and an advertisement (see the box banner ad) 102. First on the top the results of a poll vote by the percentages 104 may be shown. Below 104, there may be a video window 106 that when selected may play a video clip related to the topic area of the Poll question. To the right of the video clip there may be an ad unit 108. At the next level of the page there may be a Lead Data Point 110, which is a source article the poll question may have been written in conjunction with.

Below Lead Data Point 110, there may be a map of voters 112, for example, a worldwide map of voters. Users can zoom into countries, states, counties, even congressional districts. At the next level there may be a graphical representation 114 of the demographics breakdown of all the voters. At the next level scrolling down, as shown, are exemplary ways 116 to break down the data into different views based on different key fields. And at the bottom, as shown, for example, is the ability to share this Insights Page with others over social media channels 118.

The framework (such as which analytics modules and in what order/level) may be configured originally by a system admin. Modules, such as 102, 104, 106, etc., may be deployed automatically and updated with new and current info as interactivity occurs across the Internet to the content. For example, map of votes 112 and statics 114 and 116 may be updated in real-time or near real-time as voters vote on the poll.

FIG. 1.1 is another example of an Insights Page, in accordance with an embodiment of the present application. The page behind the Insights page (partially hidden) hosts the Widget and when “Learn More” within the widget is selected, the Insights Page 120 (the page on top) appears, potentially branded. Below there may be a video module 122 with most likely (but not necessarily) a relevant video to the content in the original Widget and next to that there may be two ad units 124 and 126.

At the next level there may be an interactive map 128 of the votes on that poll from around the world. Users can zoom into countries, states, counties, even congressional districts. At the next level and to the left there may be Poll Statistics 130 and to the right demographic breakdowns 132 of those poll statistics. At the next level there may be a module 134 called “Compare and Contrast” that shows this poll question results against other ones. At the bottom of this Insights Page there may be a Comments section 136 and another ad unit 138.

This Second Page may follow the look-and-feel of the main site of the publisher and be a host of monetization capabilities, such as online advertising or donations solicitation. It can also include a “Compare and Contrast” section showing the difference in opinion for this poll between the publisher and other sites that hosted this poll and collected votes. Third-party ad networks providing “programmatic advertising” can be inserted at levels in the Insights Page.

In short, 1World's Insights Page allows users to have a more detailed look at the poll results and analytics of the particular subject(s) while offering new ad inventory to the publisher; and it may not require any manual editorial work to build, launch, or maintain.

The following sections may be included in 1World Second Page that provides Engagement and Analytics in automated way. The page can include any one or more, or any suitable combination of features.
Quick poll statistics with percentages on each answer.
Video section: if configured shows related video content and video ad as pre-poll or post-poll. If a poll has crowd-sourced or editor provided video associated with the poll it will be displayed in this section.
Lead Data Point: source article with which the poll is associated.
Detailed poll statistics with breakdowns by demographics (gender, age, education, political affiliation, income).
Interactive Map, allowing to zoom-in and zoom-out and see how participants voted based on countries, states and zip codes/congressional districts. p1 Social comparison: this section allows user to see how their friends voted on the question and requires login to social network to be able to see this info.
Invitation to participate: this section offers readers to ask their own question on the topic covered by Insights page; submitted poll goes to moderation queue and requires users to identify themselves
Compare & Contrast: shows the difference in opinion for this poll between the publisher and other sites that hosted this poll and collected votes.
Related content: section that displays partner widgets that provide additional content, such as comments, e-commerce recommendation, other static or interactive elements that supplement the topic of the article/poll.

The logic of building Second Pages may include the following considerations:
Static configuration options, such as section inclusion On/Off or Yes/No setting.
Dynamic configuration options, e.g., the logic of displaying video content and related video advertising is based on Ad Network and behavior of related ad tags that serve it conditionally.
Votes number dependent options, e.g., if the number of votes is below threshold, for example 20 votes, that makes the graphics view meaningful, then “teaser” is displayed in certain sections, e.g., “Invite your friends to vote!”

The following info about each user may be analyzed:
geographic location;
the answer he/she chose for this question;
the answers he/she chose for other (related) questions;
demographic data (e.g., age, gender, marital status, education, income, political affiliation) he/she provided to 1World;
demographic data (e.g., age, gender, marital status, education, income, political affiliation) that could be extracted from his/her social network profile;
personality insight.

The following info about other users could be analyzed for comparison with current user:
geographic location;
the answer they chose for this question;
the answers they chose for other (related) questions;
demographic data (e.g., age, gender, marital status, education, income, political affiliation) they provided to 1World;
demographic data (e.g., age, gender, marital status, education, income, political affiliation) that could be extracted from their social network profile;
personality insight by IBM Watson.

Any info listed above may be used separately or in any combination. Some examples:
1. Use geo location to display voting stats per county/state/county/district as a map and a table. This voting map and table could automatically zoom in to:
   the country/state where the most votes came from.
   the country/state where the current user is from.
2. Use voting stats breakdown based on demographic data:
   predict current user's demographic data based on the answer he chose and demographic data of other voter's who chose the same answer.
   display voting stats by other voter's who have the demographic data as current user.
3. Use voting stats for other (related) questions:
   display voting stats intersection for two different questions like '70% of people, who prefer casual clothing, would buy iPhone as a next smartphone;
   predict current user's answer to another (related) question based on answers chosen by other vote's who chose the same answer for current question as current user did.
   predict current user's answer to another (related) question based on answers chosen by other voter's who have the demographic data as current user.

The Insights Page can have different embodiments. This second page of content, statistics, and infographics, related to the first page where the content subject was introduced, can be applied to desktop or laptop computer screens, tablets such as the iPad, mobile and smart phones, kiosks in public or semi-public places, or any other digital screen of information. The Insights Pages can be used for any content subject, from headline news, to entertainment content, to hobbies, to nearly any subject matter. The information or graphics residing on these Insights Pages is configurable by the administrator of the site or web/mobile area, and can include one or more of the additional content modules listed above in the description of the Insights Page.

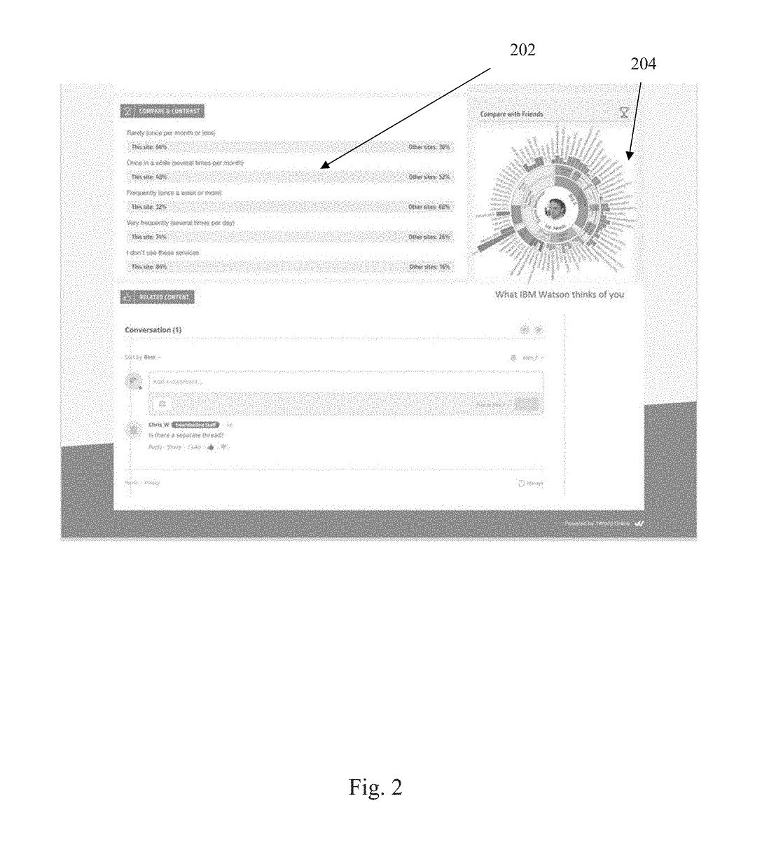

FIG. 2 is an example of a “third page” Insights Page launched from within an Insights Page, in accordance with an embodiment of the present application. As shown in FIG. 2, another Insights Page 202 can be launched from within an Insights Page 204. The Insights Page could be a third or fourth page after the second page of Insights. In other words, after “Learn More” is clicked and the Insights Page then appears, additional drill-down or related content pages may be launched, thus providing even more relevant content and additional advertisement inventory for monetization by the web publisher. And these additional Insight Pages could be from third-parties as well.

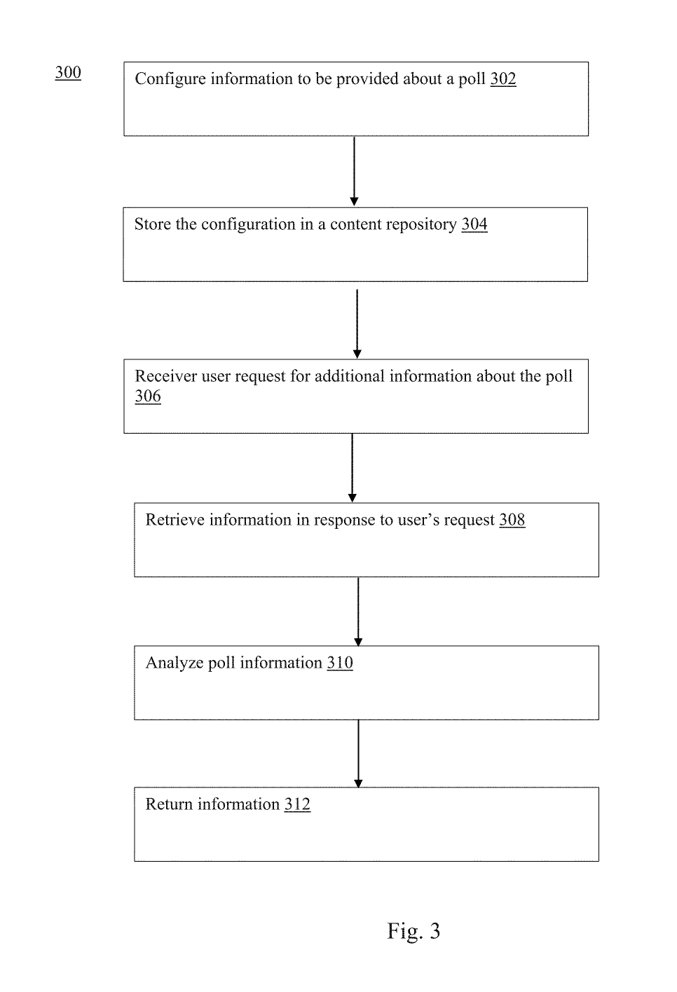

FIG. 3 is a flow chart illustrating an exemplary method 300 for providing Insights Page, in accordance with an embodiment of the present application. At step 302, information to be provided about a poll is configured. In some implementations, the information comprises information in addition to a question and text of one or more answers of the poll. In some embodiment, the configuration may be static. For example, the configuration may comprise an “on/off” option indicating whether or not to provide certain information. In another embodiment, the configuration may be conditional, depending on real-time statics of a poll. For example, if participation of a poll is below a threshold, then encouraging to participate in the poll may be provided. At step 304, the configuration is saved in a content repository. At step 306, a user request for additional information (e.g., an Insight Page) about a poll is received. At step 308, in response to the user request, the additional information is retrieved. The composition of the information is a based on a previously established configuration indicating what information will be provided. As discussed above, the additional information may be related to the poll, comprising video, poll statics. The configuration may be manipulated by an administrator of the poll publisher. At step 310, analysis of the additional information is performed. For example, compare and contrast analysis may be performed. In some implementations, at least some of the analysis may be performed in real-time. In other words, the analysis, such as comparing the user's answer to other users' answer, is performed upon user's request for additional information. In other implementations, at least some of the analysis is performed prior to user's request. At step 312, corresponding information is returned. As discussed above, how the information is presented is also configurable. For example, an administrator may configure where an ad unit may appear on the Insight Page, or where a video may appear on the Insight page.

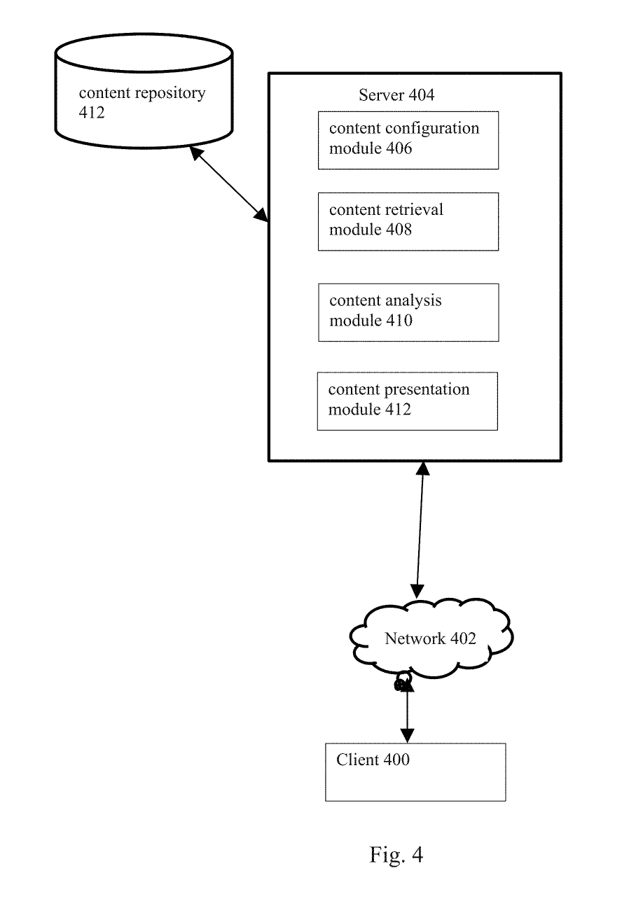

FIG. 4 shows a block diagram with components for providing Insights Page, in accordance with an embodiment of the present application. A client device 400 is connected to a network 402 which may be, for example, the Internet. The client 400 sends a request for an Insights Page, which is managed by server 404. Server 404 may comprise content configuration module 406, content retrieval module 408, content analysis module 410 and content presentation module 412.

In some implementations, content configuration module 406 may be responsible for configuration such as what information should be provided in an Insights Page. In some implementations, content retrieval module 408 may retrieve information to be provided in an Insight Page. In some implementations, content analysis module 410 may analyze information to be provided in an Insight Page, such as compare and contrast. In some implementation, content presentation module 412 may be used to configure what specific information, such as video, interactive map, should be displayed on an Insights Page. In some embodiments, the content presentation module may be used to configure where within a displayed page (e.g., an Insights Page) to display certain information. Content repository 412 may store information, including but not limited to poll statics, ads, user profiles, etc.

### Second Embodiment: Smart Profiling for a Smart Data Presentation System

This embodiment relates generally to online polling, psychographic profiling, and data presentation, and more specifically to using online polling and related mechanisms to gather information on respondents to create a psychographic profile for each respondent and then use that psychographic profile to present information custom to that reader most closely fitting their profile. In some implementations, respondents may be profiled against a 2×2 matrix for options beyond a more neutral answer or presentation of information, which then triggers intelligent presentation of data to each respondent. In some implementations, respondents may be profiled against 1 or more than 2 parameters.

Within Internet and online venues and digital properties, what are known to many as Content Management Systems (CMS) and Big Data services, there is an increasing desire customize and personalize the information presented so as to provide better online end-user acceptance and engagement with the data to thus have better outcomes. In particular, there is unmet demand to provide this data personalization and customization in a practical manner as it is nearly impossible to create and provide in near real-time different yet coherent narratives of text to thousands of users.

Providing content and paragraphs of text can be customized for a particular individual if one knows who that person is so as to target the messaging accurately. But this cannot be done practically at the speed at which, for example, Web site users across the Internet come in and out of a particular Web site and provide from a set of custom pages for each and every Web site viewer of an audience of that particular web site content. The same is true for content presented on mobile phones with screens and other digital devices connected to data networks like the Internet. While digital advertisement, like banner ads, can be targeted for each unique visitor to a web site, the same is not true for the content such as photos, graphics, and especially the paragraphs of text of the website itself. Web site text can be changed depending on various factors, but there is not a coherent system to do this to cater to worldviews of the web site viewers.

There is therefore an unmet need to provide a way for digital data providers, such as those hosting informational web sites, to publish highly engaging content that is targeted for a user/site visitor based on their worldview in a highly scalable manner to support an audience of thousands or even millions.

This embodiment contemplates an online content management system that is connected with a smart profiling engine that can, over time, segment people into a psychographic profile and present data, primarily but not limited to text data, that is targeted for that user of the system, such as web site visitor. The embodiment is not limited to web sites, but for simplicity sake, the description of the embodiment will consider this use case, the most common one it is assumed, of a web site with customized content.

The system may comprise three steps to the process: data gathering, smart profiling, and smart data presentation.

The first step in the process is data gathering via the use of online polling and surveys (e.g., online, written, or via phone) and similar methods such as online quizzes or giving opinions to online debates to gather data from users and web site visitors. Furthermore, the user may be matched with other databases, such as those provided by voter record databases, such as those curated by vendors L2 and Aristotle, which give indication of the preferences and political stances. The data gathered centers around getting at evidence that indicates the user's worldview and personal psychology.

The data gathered on individuals could include a vote on a poll question such as “Do you believe the world is a safe place?” Voting “no” to this question points to a more conservative worldview. One question answered or otherwise one data point does not conclude definitively as to a person's worldview, but after a series of data points, each scored as to the answers given, a profile starts to emerge.

Poll and survey questions are easy to understand as to the data gathering: a direct question is asked, and a multiple choice set of options provides one or more concrete answers to the question. But other modes of data gathering can be used as a prelude and inputs to the profiling step. For example, an online debate between two experts, each espousing their views on a topic, can be used in the data gathering step; for example, the viewer can click on a thumb's up icon on the user's screen to indicate his/her preference to one side of the argument being made.

Another example of a data gathering venue is an online quiz. A quiz could, for example, be about your knowledge of recent US President's and their policies. If the quiz answerer knows most of the policies and policy achievements of Jimmy Carter, Bill Clinton, and Barak Obama (all Democrats) but very little of Ronald Reagan, and the two Bush presidents (all Republicans), the conclusion can be made that the voter is more Democrat than Republican, and thus that quiz voter's worldview is somewhat known.

The types of data gathered can include other sources such as web navigation through one or more web sites, time spent on a web or mobile site reading certain articles, “Likes” and other responses to social media posts and inquiries, requests for information (such as providing your email to a particular societal, cause/issue campaign, or personal interest—such as “Save the Rainforest” or inquires for a Bible study class for one's self), or any other action that could be considered indicative of one's beliefs, views, or preferences.

The second step in the process is smart profiling. A “smart profile” may be created of each user as they provide their direct input to these various (and primarily but not exclusively online) venues discussed in the paragraph above, with additional profiling or confirmation of the initial profiling from indirect sources such as third-party databases or geo-location data. The smart profile in general can include responses from polls and surveys, demographic information (e.g., age, gender, income, zip code of residence, etc.), additional psychological profiling (from other online venues and their data gathering or profiling modules or formal personality test such Myers-Briggs).

The smart profile for this particular Smart Data Presentation System can be created without third party data sources or tools. Indeed, the speed and simplicity of how to create smart profiling system may be a major benefit to the System. A few data points may size up a person enough to profile them enough to be effective in the goal of presenting customized information to meet that person's worldview, and thus achieve a more optimum level of engagement with the content being presented.

An aspect of this embodiment is the smart profiling of an individual may be a process, a system of data gathering, from various type of data gathering venues (see above) to across different hardware (PC, smartphone, kiosks, etc.) and software or web sites and even over time. This process is a Profile Mapping. And then this Profile Mapping may be plotted across two scale measurements of two types of traits, including but not limited to world views, belief systems, or preferences each with an independent measurement yet using the same quantifying approach (e.g., both 0 to 10 scales of measurement). This Profile Mapping may be done within the framework of a 2×2 matrix of answer variance from a neutral view where each user can be placed somewhere within this landscape. If both measured areas, after enough profiling information has be gathered and individually scored, show a “high” score in both categories being measured, then that individual may be mapped in the “upper right-hand corner” quadrant of the 2×2 matrix.

Profile mapping a person a 2×2 matrix of two types of traits, such as world views, belief systems, or preferences, provides the ability to target content more relevant to that person's values and beliefs, and thus much more highly likely to resonate with that user, providing higher engagement and a higher likelihood of achievement of a goal. The goal may be fully determined by the purpose of the web site. For example, it could be to persuade a potential voter to a candidate or cause or simply to have more time on the web site and more page views to increase monetization through online advertising. Web site authors may desire high engagement by connecting with their readers of their content and this can be considered the baseline goal.

The profile mapping in a 2×2 matrix can be achieved with any two measurements. The two measurements that have the high utility in a political context, although it applies to many contexts (see below for a discussion of other possible measurements), is using Social Dominance Orientation (SDO) and Right-Wing Authoritarianism (RWA). It should be noted that SDO and RWA are non-limiting embodiments.

Social Dominance Orientation (SDO) is a personality trait that predicts social and political attitudes, and is a widely used social psychological scale. SDO is conceptualized as a measure of individual differences in levels of group-based discrimination. That is, it is a measure of an individual's preference for hierarchy within any social system and the domination over lower-status groups. It is a predisposition toward anti-egalitarianism within and between groups. The concept of SDO as a measurable individual difference is a product of social dominance theory.

Individuals who score high in SDO desire to maintain and, in many cases, increase the differences between social statuses of different groups, as well as individual group members. Typically, they are dominant, driven, tough, and relatively uncaring seekers of power. People high in SDO also prefer hierarchical group orientations. Often, people who score high in SDO adhere strongly to belief in a “dog-eat-dog” world.

Right-Wing Authoritarianism (RWA) is a personality and ideological variable studied in political, social, and personality psychology. Right-wing authoritarians are people who have a high degree of willingness to submit to authorities they perceive as established and legitimate, who adhere to societal conventions and norms, and who are hostile and punitive in their attitudes towards people who don't adhere to them. They value uniformity and are in favor of using group authority, including coercion, to achieve it.

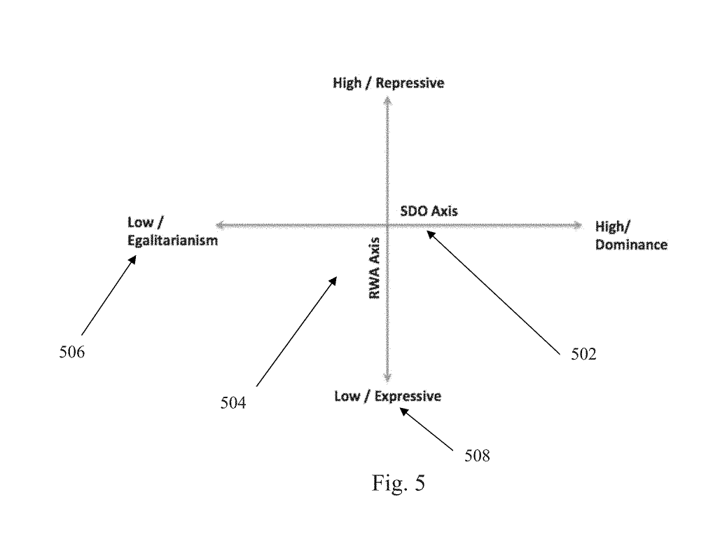

FIG. 5 is an example of a 2×2 matrix using SDO as one axis and RWA as the other axis, in accordance with an embodiment of the present application.

In FIG. 5, the two measurements, RWA and SDO, may be put together in a manner creating four quadrants, with SDO Axis 502 as the horizontal axis, and the RWA Aixs 504 as the vertical axis. Each quadrant represents the results of those two measurements for each. Measurement could be on any scale, 1 to 3, 0 to 10, 1 to 100, etc., and even verbal converted to numeric, such as a survey question with answers as very low (e.g., 1), low (e.g., 2), neutral (e.g., 3), high (e.g., 4), and very high (e.g., 5).

For example, the measurement may be on a 0 to 10 scale, someone who is extremely egalitarian 506 (thus not socially dominant) would score low, such as a 1 or a 2, on the SDO axis. If that person is a highly expressive person 508 (thus not repressive) would also score low, again possibly a 1 or a 2 along the RWA axis. This may profile map that person in the lower-left quadrant.

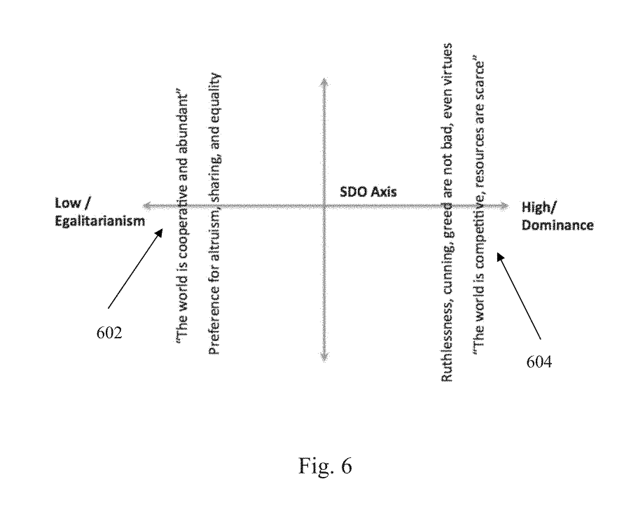

FIG. 6 is an example of a 2×2 matrix using SDO as one axis and RWA as the other axis, showing exemplary low and high in Social Dominance Orientation, in accordance with an embodiment of the present application. As shown in FIG. 6, the worldviews or answers to questions indicating worldviews may be across the spectrum of Low to High along the SDO axis. If someone believes the world is cooperative and abundant or in general has a preference for altruism, sharing, and equality, they may be considered as LOW 602 in Social Dominance Orientation. If a person believes that the world is competitive and that resources are scarce and in general believe the ruthlessness, cunning, greed are not bad things and possibly even virtuous, they may be considered as HIGH 604 in Social Dominance Orientation. Poll questions, for example, may be constructed to get at the answers to these questions, and thus the scoring of that person.

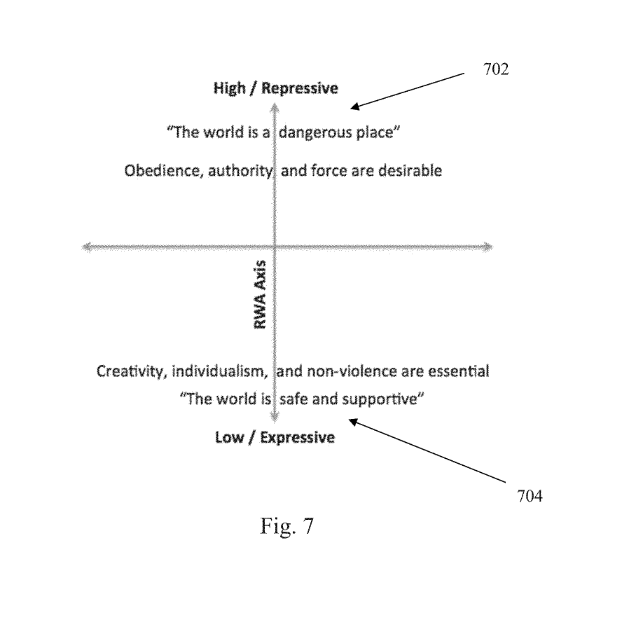

FIG. 7 is an example of a 2×2 matrix using SDO as one axis and RWA as the other axis, showing exemplary low and high in Right-Wing Authoritarianism, in accordance with an embodiment of the present application. As shown in FIG. 7, the worldviews or answers to questions indicating worldviews may be across the spectrum of Low to High along the RWA axis. For example, if someone believes the world is a dangerous place or in general has a preference for obedience, authority, and force, then they may be considered as HIGH 702 in Right-Wing Authoritarianism. If a person believes that the world is a safe and supportive environment and believe that creativity, individualism, and non-violence is important, then they may be considered as LOW 704 in Right-Wing Authoritarianism. Poll questions, for example, can be constructed to get at the answers to these questions, and thus the scoring of that person.

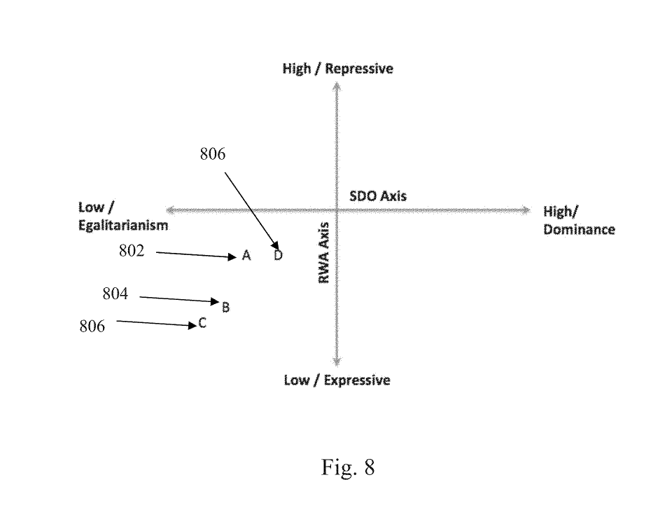

Thus, by combining SDO and RWA into a 2×2 matrix and after, for example, four poll questions are answered (scores to answers of respective questions labeled “A” through “D”), a person may be mapped in the following quadrant as shown in FIG. 8.

FIG. 8 is an example of a 2×2 matrix using SDO as one axis and RWA as the other axis, showing an exemplary person mapping onto the 2×2 matrix, in accordance with an embodiment of the present application. As shown in FIG. 8, answer A 802, answer B 804, answer C 806, answer D 808 may be mapped onto the 2×2 matrix. This profile mapping may indicate that this particular person is more expressive and egalitarian than most other people, scoring relatively low on both SDO and RWA scales.

Following this logic, there may be four quadrants, as shown in FIGS. 5-8 that any one particular person could fall into.

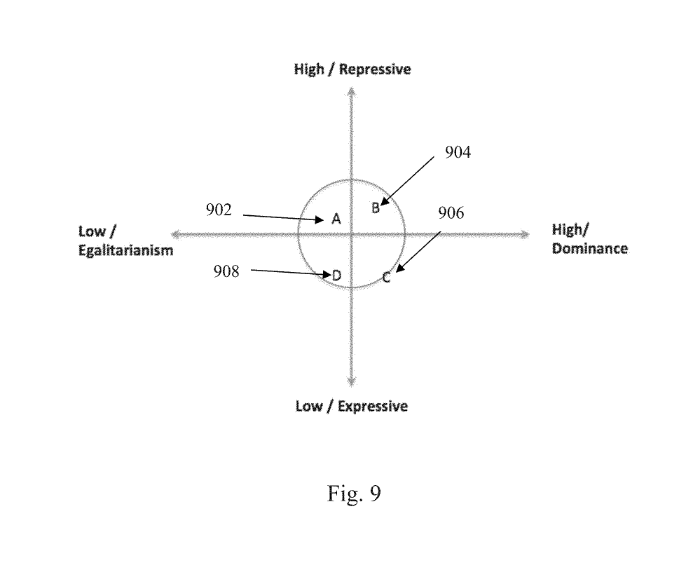

FIG. 9 is another example of a 2×2 matrix using SDO as one axis and RWA as the other axis, showing an exemplary person mapping onto the 2×2 matrix, in accordance with an embodiment of the present application. As shown in FIG. 9, there may be a fifth mapping, that of someone moderate on both SDO and RWA scales, where these same four poll questions answered may have the mapping shown in FIG. 9, answer 902 to poll question A, answer 904 to poll question B, answer 906 to poll question C, and answer 908 to poll question D.

This mapping of a user into five categories may be a worldview audience segmentation. The profile mapping process of a web visitor or user of a digital system would rate the responses to various poll (or related) questions as revealing their worldview. This may be smart profiling with an applied purpose and one that is practical for content creation.

Once this mapping is done for each user of the system, the third step in this process may occur, that of smart data presentation. This is where a portal system may come into play allowing constructors of web sites to submit text narratives to populate web pages. The default case may be moderate (or neutral) on the two axes. The CMS portal to the web site may take text initially for all web pages as the base case, default worldview, or at least this may be the assumption on how the system workflow would operate. Once that (moderate/neutral) default text is written, four additional variations of the text narrative may be written targeting the specific psychographics of someone in each particular quadrant. A detailed explanation by way of example of how four variations of text may be written is provided below. Variations of text narratives may be uploaded into the CMS portal for at least some web page.

Default text may be presented as standard for any new visitor. After a smart profile to the quadrant of a web visitor is identified, at least some quadrant-specific pages may be shown to that web visitor, matching the text written for that quadrant specifically. The text may be matched to the user profiled—the text narrative thus may be optimally presented as being written by an author having that same worldview, preference, psychographic make-up, etc., of the user (web viewer/visitor). Thus, the content may conform to the worldview of the web visitor, increasing his/her level of engagement and agreement with the material. The customized worldview presentation of the data (to one of the five options) may occur for every web visitor. It is contemplated that the core content itself may be the same in all five psychographic options, but worded differently and bringing out different points and highlighting some areas and not others. The presentation of the customized worldview text may happen in real-time across millions of viewers of a web audience.

An example of how to score a set of questions and answers will be shown here as an illustration of how this Smart Data Presentation may work. First, a web visitor answers five poll questions that are set-up in a 1World poller. The example here of five questions in one poller widget is just one embodiment of how the data gathering can work. Here is what the five questions could be in this hypothetical case:
Take our Quick “Politics and You” Quiz
1) Do you consider yourself sympathetic to the principles of the Tea Party movement?
   Absolutely, and those that don't understand frustrate the hell out of me
   Yes, but the movement fails to organize itself well enough
   No, but I can understand the frustration with our current government
   No way, and I think those people are nuts
2) Do you believe in Global Warming and what should we do about it?
   Yes, global warming is man-made and humanity should work together to solve it as a world priority
   Yes, global warming is real whatever the cause, and only market-based measures can solve it
   Maybe global warming is real, but there is little we can do about it, nature is bigger than humanity
   No, global warming is not real, and if we hamper our businesses in control laws we may lose to China, others
   Prefer not to answer
3) Do you worry about crime?
   Yes, these are dangerous times and people can be ruthless and evil
   Yes, but not all the time and only worried about certain individuals
   No, but I understand fears people have about crime and don't trust everyone
   No, I feel safe almost all the time and believe most people are good souls
4) What is your basic philosophy on international trade deals the USA has or may make?
   World trade helps all nations enter the 21st century, we can trust foreign partners, deals make sense
   World trade can be a positive thing for all parties, done right—it is possible but not a guarantee either
   Trade deals have had a mixed track record, we have to be careful going forward in these deals
   We can't trust international players, we should focus on our country and people, penalties should be slapped on cheaters
   Prefer not to answer
5) What is your preference of the top traits of your county's President?
   Consensus builder and crosses party lines to get things done
   Honest and takes responsibility for decisions, transparent
   A world stage negotiator, ready to go war if needed
   Strong, takes no crap from anyone, calculating in getting things done as needed

The above may go through a scoring system, which may require the admin user to enter in scoring on a 0.1 to 10.0 scale. 5 may be perfectly neutral. Low numbers may be low SDO or RWA scores, high numbers may be high SDO or RWA scores. The 0 to 10 scale can also be done on a 5 point scale, such as Very Low, Low, Neutral, High, Very High. Multiple selections may be allowed in the answers.

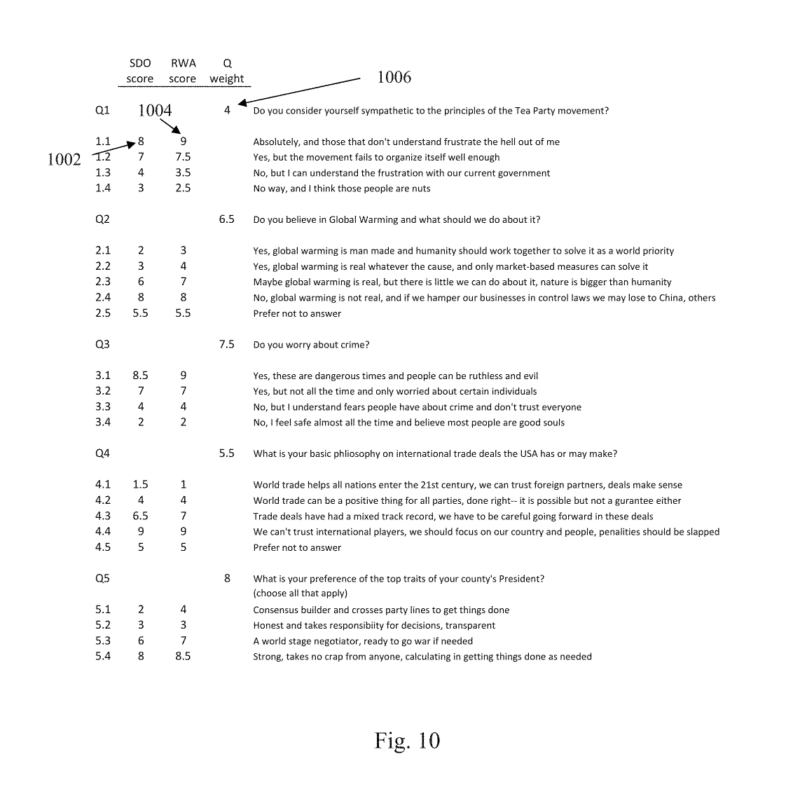

FIG. 10 is an example of scoring for five exemplary questions indicating worldview, in accordance with an embodiment of the present application. As shown in FIG. 10, each answer may be given a SDO score 1002 and a RWA score 1004. Each question may also be given a weight 1006. For example, as shown in FIG. 10 and above, question “Do you consider yourself sympathetic to the principles of the Tea Party movement” may be given a weight of 4. Answer “Absolutely, and those that don't understand frustrate the hell out of me” to question “Do you consider yourself sympathetic to the principles of the Tea Party movement” may be given a SDO score of 8, and RWA score of 9.

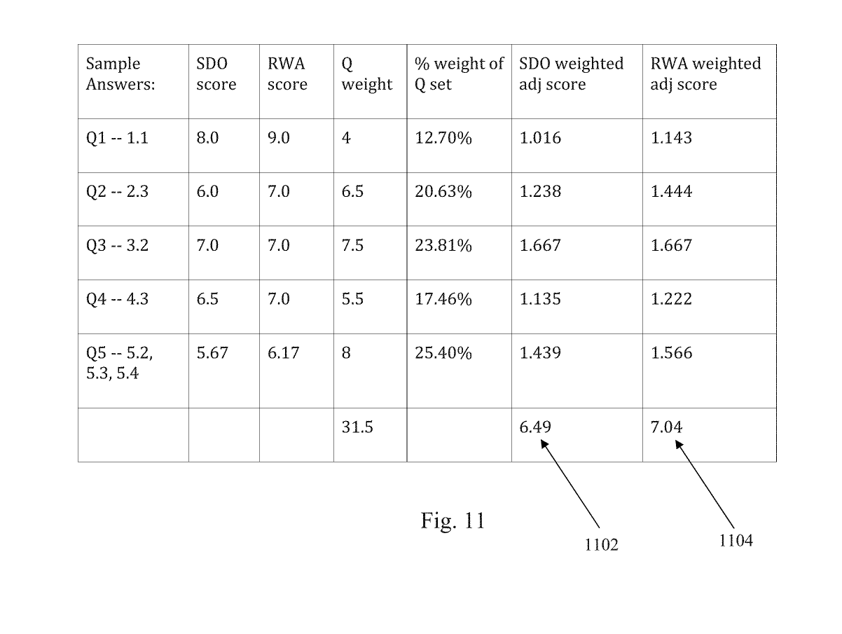

FIG. 11 shows example scores of an end-user answering five questions. As shown in FIG. 11, based on the user's answers, the user's SDO weighted adjusted score 1102 for all 5 questions is 6.49 and the user's RWA weighted adjusted score 1104 for all 5 questions is 7.04.

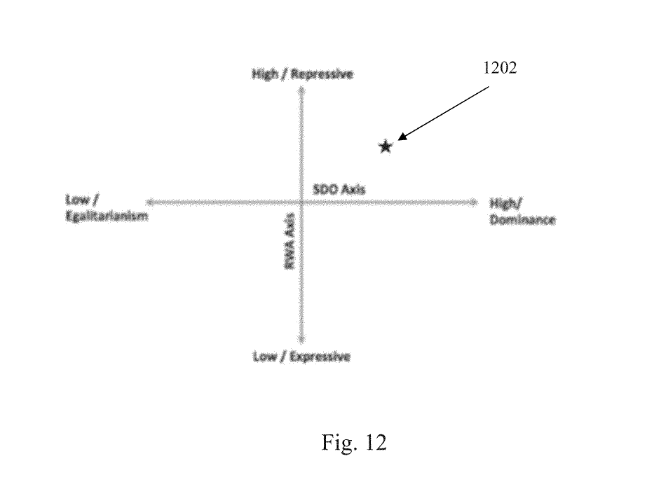

FIG. 12 is exemplary SDO and RWA scores of a user, plotted in a 2×2 matrix using SDO as one axis and RWA as the other axis, in connection with FIG. 11, in accordance with an embodiment of the present application. As shown in FIG. 12, a user's SDO and RWA is plotted as 1202.

Thus, this end-user has been “smart profiled” as someone with high social dominance and a high or repressive RWA outlook. This was an example set of answering; other answers could have put the end-user in another quadrant. Messaging to this end-user may be catered according to his/her SDO/RWA scores. Let's next examine how that might work, catering the messaging for the individual's worldview.

Assume that there is a woman running for Congress and her campaign team decides to adopt this Smart Data Presentation System for their Web site. Let's further assume there is an “Issues” menu item, and one of those items is on abortion. This candidate is against abortion, but not strictly so, and wants to align herself with pro-lifers, and blunt the criticism from those that are pro-abortion. The content management system input system may start with asking for the neutral statement, which could be: “I am against abortion, except in the case of rape, incest, or if the life of the mother is at stake.” Note that this is neutral in terms of the candidate's presentation of their actual position, not a value commentary on the issue itself.

Now four additional restatements of this neutral statement on the issue may be prompted/created, for example such as:
High RWA, High SDO: “I am against abortion, life is sacred”
High RWA, Low SDO: “I am against abortion, and while the guidelines should be firm here, there are notable exceptions to an all out ban, like in cases of rape or incest.”
Low RWA, High SDO: “I am in general against abortions, but if they are to be done these procedures should be performed in monitored and safe medical facilities”
Low RWA, Low SDO: “I am against abortion but our government allows for it, so I won't stand in the way of the law.”

Thus, the Smart Profiling System/web page may now know that the end-user is High SDO and High RWA and may automatically show the end-user/web visitor, when he/she visits the Issue page on abortion, the appropriate messaging: “I am against abortion, life is sacred.” Other web visitors, those that have answered enough questions to be scored, may automatically be shown different messaging depending on their worldview orientations. Note that all the information being communicated may be reconciled with the same underlying stance, just different aspects may be brought out and other items may not be mentioned. The web viewer may thus be seeing and hearing things that are more suitable for him/her, drawing him/her more so to that candidate than if the messaging was not parsed through this Smart Data Presentation System.

This Smart Profiling for a Smart Data Presentation System may have different embodiments. The parsing of content and messaging to web visitors may be applied to desktop or laptop computer screens, tablets such as the iPad, mobile and smart phones, kiosks in public or semi-public places, or any other digital screen of information. While this application may be for use in politics and public affairs, it may be applied to any subject area, including but not limited to headline news, entertainment content, and hobby-interest stories.

As mentioned above, the inputs to the scoring system for users, individually, as groups, or as a whole, may be varied. It may not be common that people fill out long surveys allowing for easy profiling. The scoring, such as in the RWA vs. SDO scalings, may include but is not limited to a collection of answers from single poll questions, multiple poll questions in one widget, quiz answering, providing a social media like, clicking on a thumbs up or down button, providing support for one side of an online debate, the navigation trail of an end-user through a web site (such as clicking on “Learn More” and bringing up an Insights Page), time spent watching particular online videos, the set of content one reads on a web site or across web sites, magazine subscriptions, and of course surveys, online or offline.

A key wide-application of this disclosure may be the use of the 2×2 grid on other axis measurements to smartly present information to readers that is best suited for each individual viewer's psychographic make-up (such as their worldview). For example, instead of RWA vs. SDO, it could be on one axis a scale of highly Introverted to highly Extroverted and on the other axis a scale from preferring outdoor-physical activities to preferring indoor-cerebral activities. Then, in a similar fashion as outline in this section, a series of questions may be asked—from polls questions integrated natively within the content and individually or upfront in a rapid-fire multi-choice survey method (or hybrid methodologies)—to thus calibrate that web visitor in the proper quadrant, and from there place him or her having a certain set of preferences (similar to a worldview in RWA vs. SDO) to thus target the most likely to be appreciated/most-likely-to-be-absorbed one of four or five different ways of providing the same general message (or set of content), all of which may be done automatically and at high speed servicing millions of web visitors simultaneously.

Quizzes to determine a person's SDO or RWA score exist in isolation, such as this one: https://www.shroomery.org/forums/showflat.phpNumber/11860860. John Duckitt is known to have combined Social Dominance Theory and RWA in psychological analysis in the past and plenty of psychologists or researchers have looked at these personality dimensions in tandem. Personality tests exist that measure both. But today, no online quiz or question asking and scoring system on Web sites for the causal Web visitor or regular Internet reader is out there that scores both SDO and RWA at the same time outside of pure psychological tests. Nor is content management used in a real-time match to the web visitor's personal psychographics with the conceived smart profiling system (which quadrant) determining which content to display, such as on a web page (when you now know that person's world outlook and viewpoints). Customization of the content being displayed by an online end-user's smart profiled mapping as defined above is a unique innovation.

The Smart Presentation System may automatically select particular, pre-programmed content designed and crafted knowing the personality quadrant to cater to so as to win friends and influence people in political elections and cause/issue campaigns. The 2×2 grid matrix may be used as a way to present information (Smart Presentation System) predisposed to be acceptable to the reader (independent claim) and the RWA-vs-SDO used as a unify scoring system.

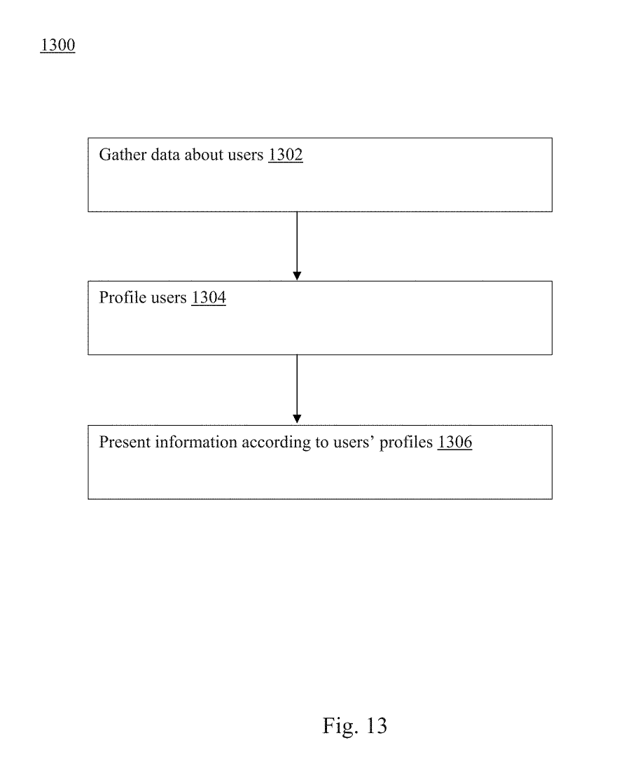

FIG. 13 is a flow chart illustrating an exemplary method 1300 for Smart Profiling and Presentation, in accordance with an embodiment of the present application. At step 1302, data about users is gathered. In some implementations, at least some of the data reflect the user's worldview or belief. The data may be gathered through online quizzes. Various mechanisms to encourage user's engagement to supply his/her worldview may be employed. At step 304, the users are profiled. In some implementations, the users may be profiled for their SDO and/or RWA. The profiling may use various scoring mechanisms, with various weights. At step 306, information may be presented to the users according to the users' profiles. In some implementation, texts in different narrative forms are presented to the users according to their profiles. The texts, although in different narrative forms, may share and/or be based on same facts, stances, core concepts, etc.

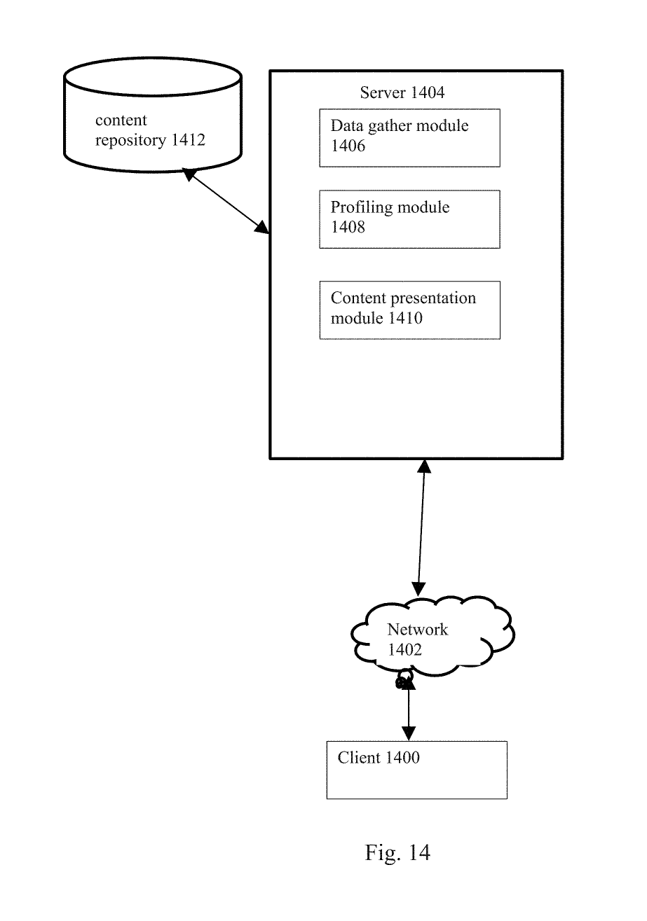

FIG. 14 shows a block diagram with components for providing Insights Page, in accordance with an embodiment of the present application. A client device 1400 is connected to a network 1402 which may be, for example, the Internet. The client 1400 interacts with server 1404 directly or indirectly. Server 1404 may comprise data gather module 1406, profiling module 1408 and content presentation module 1410. Data gather module 1406 may be responsible for gather user information, such as user's SDO or RWA profiles. Profiling module 1408 may be responsible for profiling users based on users' information that has been gathered. Content presentation module 1410 may be responsible for presenting content to the users according to users profiles. Content repository 1412 may be responsible for storing users' profiles.

### Third Embodiment: In-Place Analytics

The third embodiment relates to an online element of web site interactive widgets that may allow both end-users and administrators to click to see analytics from within that particular widget, in situ. This third embodiment may share similar functionalities and benefits of the first embodiment and/or the second embodiment. This third embodiment may share similar flow chart and block diagram of the first embodiment and/or the second embodiment.

A “Widget” is defined here as a software or data plug-in system to a Third-party Web Site, mobile property, or similar interactive digital environment (“web page” will be used to represent a third-party web site, mobile property, or similar interactive digital environment for simplicity sake). By “Third-party Web Site” we mean the interactive content that resides on someone else's /or some other firm's web site, one embodiment is using the web technology JavaScript and embed codes” that are inserted into the web site software of a web site hoster. A Widget can be defined space, often a square or rectangle shape, occupied within part of a Third-party Web Site. Within that Widget's area interactive content and data can be fed into it and displayed to all viewers and users of that Third-party Web Site, and this widget can match the themes and colors of the “host” Web Page. Some call this market sector of vendors selling solutions like this “the Modular Web.”

FIG. 15 is an example of an In-Place Analytics Widget, which may be inserted into a space in a Third-party Web Site, in accordance with an embodiment of the present application. The Widget's and interactivity performance—such as how many people are visiting, how many are interacting with it such as voting on a poll, how many as a percentage of other traffic, etc.—may be hard to track as accurately as the Third-party Web Site as a whole or the hosting Web Page as a whole. In-Place Analytics may address this problem, in a way that makes it most accessible for people to use it.

With In-Place Analytics, a click somewhere within a Widget may reveal, still within and only within the Widget framework, performance metrics and statistics. This performance metrics and statistics information may be automatically generated as visual results of the Widget element shown within the Widget element, in-situ. For example, if it were a poll vote on a Web page hosting the 1World Poller, doing the “Triggered Action” (defined as the action the initiates the new “screen” of information, what we are calling the In-Place Analytics screen) click may have that poll question spin around 180 degrees (graphically in the user-interface) and show the statistical and analytics results. The results may be, for example, the results of 1256 poll votes, displayed with a bar chart of the different answers given as a percentage of 100%, and other information like number of views to the poll (whether they voted or not) and demographic breakdowns of those poll voters.

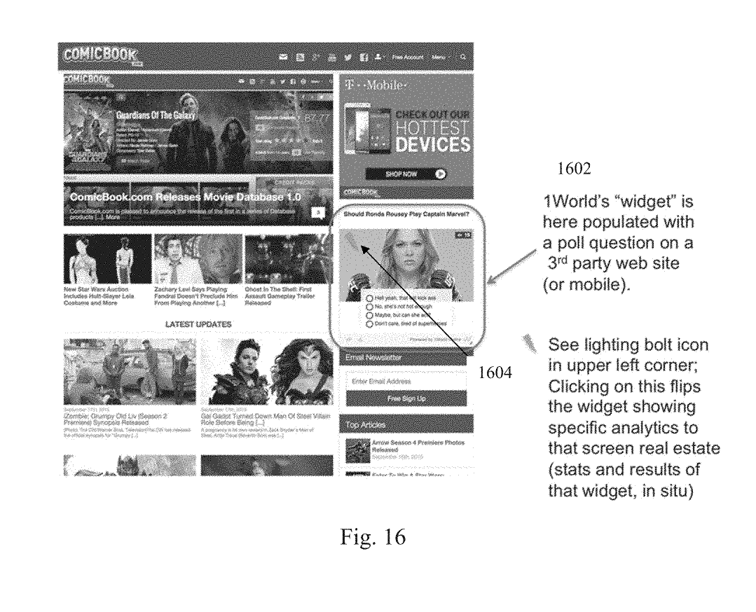

FIG. 16 is an example of In-Place Analytics Widget, in accordance with an embodiment of the present application. As shown in FIG. 16, A click on the “Trigger Area” 1604 of the screen initiates the Triggered Action. In the example as shown in FIG. 16, the Triggered Area is the lightning bolt in the upper left corner of the Widget's content area. Clicking this flips the modular content widget to show analytics of that particular Widget, the In-Place Analytics screen (for admins). Interactive content (like a poll questions) and optionally programmatically fed ads or promo banners can now immediately be better understood by 1) end-users—one “consumer” view of the content results, for example poll results and 2) Web Page (and/or remote widget) administrators—showing for them things like web traffic, demographics of the web visitors, time spent on widget, ads revenue total to date or daily from the widget.

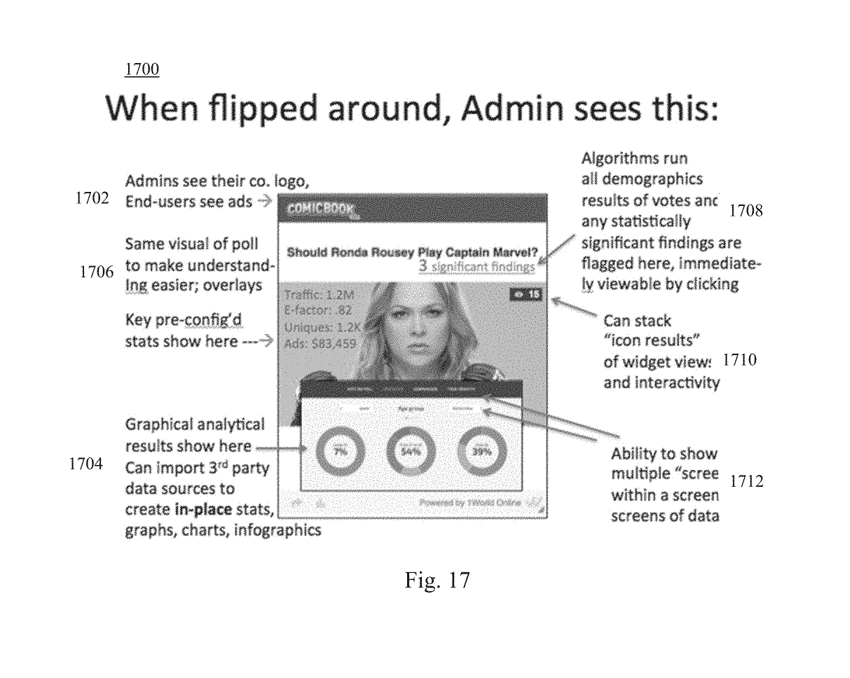

FIG. 17 is another example of In-Place Analytics Widget, in accordance with an embodiment of the present application. As shown in FIG. 17, there may be two levels of In-Place Analytics screens, one for end-users and one with more details for administrators when logged in as admins. For example, admin may be their company logo 1702, while end user may see ad.

The admin In-Place Analytics may also have APIs to bring in other information as from databases or third-party applications. The types of information that can be brought into the In-Place Analytics screens may be related, directly or indirectly, to the Widget itself. Such information may provide useful and “everyday” analytics that can be used by all employees (with admin access), at anytime, and in place to where the web site venues are located. The administrator may see the Widget on the consumer-facing Third-party Web Site, and may immediately and in-situ see the performance results 1704. Being in-situ may allow for all the performance results to be put in context. Is the Widget way down below “the fold” of the Web Page? If the performance numbers are low, the admin may see in real time the environment that Widget is operating in, and see results that are actionable and useful, when and where needed. Better decisions may be made at all levels of the web enterprise, maximizing user views, revenue, and any other important metric for all the various people (potentially customizable for each person) utilizing the system.

As shown in FIG. 17, the administrator In-place Analytics screen 1700 may display statistically significant findings 1708, for example, through one or more links. In some implementations, In-Place Analytics screen 1700 may have the capability 1710 to stack “icon stack” of widget views and interactivity. In some implementations, In-Place Analytics screen 1700 may have the capability 1712 to show multiple “screen within a screen” screens of data.

The end-user In-place Analytics may function similarly in terms of the Triggered Action and part of the content within the Widget element graphically spinning around 180 degrees as described above. End-user In-place Analytics may have less information, and the information may be more specific to the results of the Widget, such as the results of a Poll Vote.

The end-user In-place Analytics may directly relate to the two sections above (Insights Page and Smart Profiling for a Smart Data Presentation System). What the end-users sees may be, in essence, a miniature version, and really a subset of the Insights Page. The subset may be just one image or even one line item. The advertising may refresh as and when the In-place Analytics is revealed via a Triggered Action (ad refresh does not occur with admin views of In-Place Analytics screens).

In-place Analytics for end-users may also intersect with the Smart Profiling for a Smart Data Presentation System in that what results or how the results are shown may go through the “SDO vs. RWA” filter to psychographicly determine which “results” appear in the spin-around In-place Analytics screens. For example, in the use case discussed above with the five questions on political viewpoints, our sample user there was “upper right-hand quadrant”, high SDO, high RWA. If the Poll Question on this web site using this content filtering 2×2 matrix system was “do you vote for liberals”—and further suppose the result was 45% do, 40% don't, and 15% didn't answer—the results for that upper right-hand quadrant in the In-Place Analytics could be, for this end-user (not admin), that “55% don't or didn't answer” and also provide a demographic breakdown of those 40% of people that voted they don't. Meanwhile, the other end of this worldview spectrum is best exemplified by someone profiled mapped into the “lower left-hand quadrant”, low SDO, low RWA. In-Place Analytics could be, for this end-user (not admin), that “45% do” and also provide a demographic breakdown of people that voted that way.

Referring still to FIG. 17, FIG. 17 is an exemplary In-Place Analytics screen 1700 for administrators. The In-Place Analytics may show poll results 1706 by many types, such as significant findings via cross-tabulations of two different questions answered by the same voting population, traffic to that Widget, an E-factor (“Engagement factor”) which is a customizable measure of engagement level with the content or material, views of the poll (maybe without voting), the number of unique visitors to the Widget (and/or host Web Page), and the amount of money made by the programmatic advertising shown in tandem with the Widget, but the results and statistics are not limited to just these areas.

This embodiment may work similarly for end-users, that the graphics may be simpler and less information may be available (and no third-party data integration is provided).

This embodiment of Smart Profiling for a Smart Data Presentation System may have different implementations. The parsing of content and messaging to web visitors may be applied to desktop or laptop computer screens, tablets such as the iPad, mobile and smart phones, kiosks in public or semi-public places, or any other digital screen of information. While this innovation is meant for use in politics and public affairs, it may be applied to any subject area, including but not limited to headline news, entertainment content, and hobby-interest stories.

All the data that is presented on the flipped side of the In-Place Analytics module may be configurable, both by end-users and by admins. It may be crammed with information or links to information, or showing just one key statistic. By the use of APIs, any data in the world can most likely be intertwined into the flipped side of the In-Place Analytics module, and this configuration may happen in a separate interface, which itself is also potentially viewable in-situ within the module. The broad types of data beyond all the 1World interactive widget data and engagement metrics that could be integrated in this output screen include but are not limited to sales data, web traffic information, data bases of demographic profile information, cross-tabulations from other interactive module vote-action results, or any third-party data source.

At this point it should be noted that techniques in accordance with the present disclosure as described above may involve the processing of input data and the generation of output data to some extent. This input data processing and output data generation may be implemented in hardware or software. For example, specific electronic components may be employed in circuitry for implementing the functions in accordance with the present disclosure as described above. Alternatively, one or more processors operating in accordance with instructions may implement the functions in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

1. A computer-implemented method for automating presentation of data and content, the method being performed by a computing device comprising one or more processors, the method comprising:
configuring, by the one or more processors, so as to create a configuration, electronic information to be provided about a poll, wherein the electronic information comprises statistics about the poll, wherein the configuration is at least one of conditional based on a parameter or static, wherein the configuration indicates what electronic information is to be provided in response to a user request for additional information regarding the poll;
storing, by the one or more processors, the configuration in a content repository;
in response to the user request, retrieving, by the one or more processors, the electronic information to be provided based on the configuration;
analyzing, by the one or more processors, the electronic information to be provided based on the configuration, wherein the configuration further indicates what electronic information is to be analyzed;
providing, by the one or more processors, the electronic information to the user.

2. The method of claim 1, further comprising:
providing, by the one or more processors, the electronic information on a second page that shares a look-and-feel of a first page where the poll question and text of one or more answers of the poll is displayed.

3. The method of claim 1, further comprising:
providing, by the one or more processors, electronic information to encourage participation of the poll if the participation of the poll is below a threshold.

4. The method of claim 1, further comprising:
comparing, by the one or more processors, differences in answers of the poll between a first publisher of the poll and a second publisher of the poll.

5. The method of claim 1, further comprising:
configuring, by an administrator of a publisher of the poll, the electronic information to be provided about the poll.

6. The method of claim 1, further comprising:
providing, by the one or more processors, the electronic information on a second page within a first page where the poll question and text of one or more answers of the poll is displayed.

7. The method of claim 1, further comprising:
providing, by the one or more processors, a source article associated with the poll.

8. A system for automating presentation of data and content, comprising one or more processors configured to:
configure, so as to create a configuration, electronic information to be provided about a poll, wherein the electronic information comprises statistics about the poll, wherein the configuration is at least one of conditional based on a parameter or static, wherein the configuration indicates what electronic information is to be provided in response to a user request for additional information regarding the poll;
store the configuration in a content repository;
in response to the user request, retrieve the electronic information to be provided based on the configuration;
analyze the electronic information to be provided based on the configuration, wherein the configuration further indicates what electronic information is to be analyzed;
provide the electronic information to the user.

9. A non-transitory computer readable medium storing a computer-readable program for automating presentation of data and content, comprising:
computer-readable instructions to configure, so as to create a configuration, electronic information to be provided about a poll, wherein the electronic information comprises statistics about the poll, wherein the configuration is at least one of conditional based on a parameter or static, wherein the configuration indicates what electronic information is to be provided in response to a user request for additional information regarding the poll;
computer-readable instructions to store the configuration in a content repository;
computer-readable instructions to, in response to the user request, retrieve the electronic information to be provided based on the configuration;
computer-readable instructions to analyze the electronic information to be provided based on the configuration, wherein the configuration further indicates what electronic information is to be analyzed;
computer-readable instructions to provide the electronic information to the user.

10. A computer-implemented method for automating presentation of data and content, the method being performed by a computing device comprising one or more processors, the method comprising:
gathering, by the one or more processors, electronic information about users, wherein at least some of the electronic information reflects a first trait of a first user and a second trait of a second user.
profiling, by the one or more processors, the users based on the electronic information;
presenting, by the one or more processors, electronic content to the users according to users' profiles, wherein the first user with the first trait is presented with the electronic content in a first form and the second user with the second trait is presented with the same electronic content in a second form.

11. The method of claim 10, where the first trait comprises at least one of a world view or a belief of the first user.

12. The method of claim 10, further comprising profiling the first user based on a two-by-two matrix comprising four quadrants.

13. The method of claim 10, further comprising profiling the first user based on Social Dominance Orientation and Right-Wing Authoritarianism.

14. The method of claim 10, further comprising presenting the first user with the electronic content in a first narrative form and presenting the second user with the same electronic content in a second narrative form.

15. The method of claim 14, wherein the first narrative form conforms to the first trait of the first user and the second narrative form conforms to the second trait of the second user such that the first narrative form enhances a first agreement of the first user with the electronic content and the second narrative form enhances a second agreement of the second user with the same electronic content.

16. A system for automating presentation of data and content, comprising one or more processors configured to:
gather electronic information about users, wherein at least some of the electronic information reflects a first trait of a first user and a second trait of a second user.
profile the users based on the electronic information;
present electronic content to the users according to users' profiles, wherein the first user with the first trait is presented with the electronic content in a first form and the second user with the second trait is presented with the same electronic content in a second form.

17. A non-transitory computer readable medium storing a computer-readable program for automating presentation of data and content, comprising:
computer-readable instructions to gather electronic information about users, wherein at least some of the electronic information reflects a first trait of a first user and a second trait of a second user.
computer-readable instructions to profile the users based on the electronic information;
computer-readable instructions to present electronic content to the users according to users' profiles, wherein the first user with the first trait is presented with the electronic content in a first form and the second user with the second trait is presented with the same electronic content in a second form.
